(19) United States
(12) Patent Application Publication
(10) Pub. No.: US 2026/0003088 A1
(43) Pub. Date: Jan. 1, 2026

(54) Ultrasonic Device, Multi-Feed Detector, Transport Device, And Scanner

(71) Applicant: SEIKO EPSON CORPORATION, Tokyo (JP)

(72) Inventors: Masayoshi YAMADA, Shiojiri (JP); Eiji OSAWA, Matsumoto (JP); Hiroto TOMIOKA, Shiojiri (JP)

(21) Appl. No.: 19/252,463

(22) Filed: Jun. 27, 2025

(30) Foreign Application Priority Data
Jun. 28, 2024 (JP) 2024-104906

(51) Int. Cl. G01V 1/00; B65H 7/12

(52) U.S. Cl. CPC G01V 1/001; B65H 7/12; B65H 2553/30

(57) ABSTRACT

An ultrasonic device includes an ultrasonic element that performs at least one of transmission of ultrasonic waves and reception of ultrasonic waves, and a housing that houses the ultrasonic element, wherein the housing includes a reflection surface that reflects the ultrasonic waves, a waveguide through which the ultrasonic waves propagate, and an opening that is provided at one end of the waveguide and through which the ultrasonic waves pass.

The present application is based on, and claims priority from JP Application Serial Number 2024-104906, filed Jun. 28, 2024, the disclosure of which is hereby incorporated by reference herein in its entirety.

### BACKGROUND

### 1. Technical Field

The present disclosure relates to an ultrasonic device, a multi-feed detector including a pair of ultrasonic devices, a transport device including the multi-feed detector, and a scanner.

### 2. Related Art

For example, JP-A-2020-25242 discloses an ultrasonic device that detects multi-feed of sheets using ultrasonic devices. Specifically, the ultrasonic device includes a pair of ultrasonic devices disposed with a sheet transport route in between in order to detect a plurality of sheets simultaneously fed in a sheet transport device of a scanner. One ultrasonic device transmits ultrasonic waves, the other ultrasonic device receives the ultrasonic waves transmitted through the sheet, and multi-feed of sheets is detected based on the intensity of a reception signal.

According to the literature, the ultrasonic device is disposed inside a shield portion having an opening, and a mesh-like protector for suppressing intrusion of foreign matter is provided in the opening through which the ultrasonic waves pass.

JP-A-2020-25242 is an example of the related art.

However, there is room for improvement in the ultrasonic device in JP-A-2020-25242. Specifically, when the mesh is rough, there is a problem in that foreign matter such as paper dust passing through the protector adheres to the surface of the ultrasonic device and the transmission and reception sensitivity of ultrasonic waves becomes lower. When the mesh is made finer, it is necessary to clean the foreign matter adheres to the surface of the protector, and there is a problem that the moisture of a cleaning liquid and the paper dust are mixed and fixed to the protector during cleaning and the transmission and reception sensitivity of ultrasonic waves becomes lower.

That is, an ultrasonic device that is easily cleaned and has stable ultrasonic transmission and reception sensitivity is desired.

### SUMMARY

An ultrasonic device according to an aspect of the present disclosure includes an ultrasonic element that performs at least one of transmission of ultrasonic waves and reception of ultrasonic waves, and a housing that houses the ultrasonic element, wherein the housing includes a reflection surface that reflects the ultrasonic waves, a waveguide through which the ultrasonic waves propagate, and an opening that is provided at one end of the waveguide and through which the ultrasonic waves pass.

A multi-feed detector according to an aspect of the present disclosure includes a pair of the above described ultrasonic devices as an ultrasonic device for transmission and an ultrasonic device for reception, wherein the ultrasonic device for transmission and the ultrasonic device for reception are disposed with a transport route of a sheet-shaped medium in between, and ultrasonic waves are transmitted from the ultrasonic device for transmission, the ultrasonic waves passing through the medium are received by the ultrasonic device for reception, and multi-feed of the medium is detected based on intensity of a reception signal.

A transport device according to an aspect of the present disclosure includes the above described multi-feed detector.

A scanner according to an aspect of the present disclosure includes the above described transport device and a reading unit that reads an image printed on the medium.

### BRIEF DESCRIPTION OF THE DRAWINGS

FIG. 1 is a front perspective view of a scanner according to Embodiment 1.

FIG. 2 is a side sectional view showing a document transport route of the scanner.

FIG. 3 is a block configuration diagram showing a control system of the scanner.

FIG. 4 is a side sectional view showing a configuration of a multi-feed detector.

FIG. 5 is a side sectional view showing a configuration of an ultrasonic device.

FIG. 6 is a perspective view of a main board.

FIG. 7 is a side sectional view of a main part of an ultrasonic element.

FIG. 8 is a side sectional view showing a configuration of an ultrasonic device according to Embodiment 2.

FIG. 9 is a side sectional view showing a configuration of an ultrasonic device according to Embodiment 3.

FIG. 10 is a perspective view of a protector.

FIG. 11 is an enlarged view of the protector.

FIG. 12 is a side sectional view showing a configuration of an ultrasonic device according to Embodiment 4.

### DESCRIPTION OF EMBODIMENTS

### Embodiment 1

### Outline of Scanner

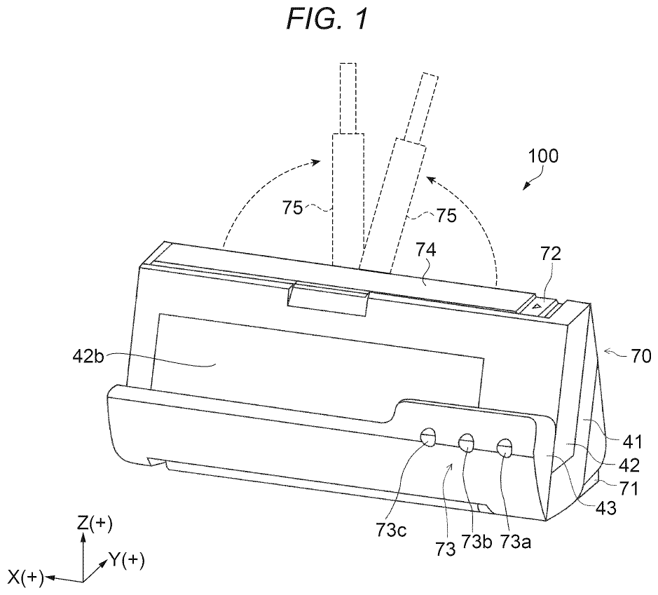

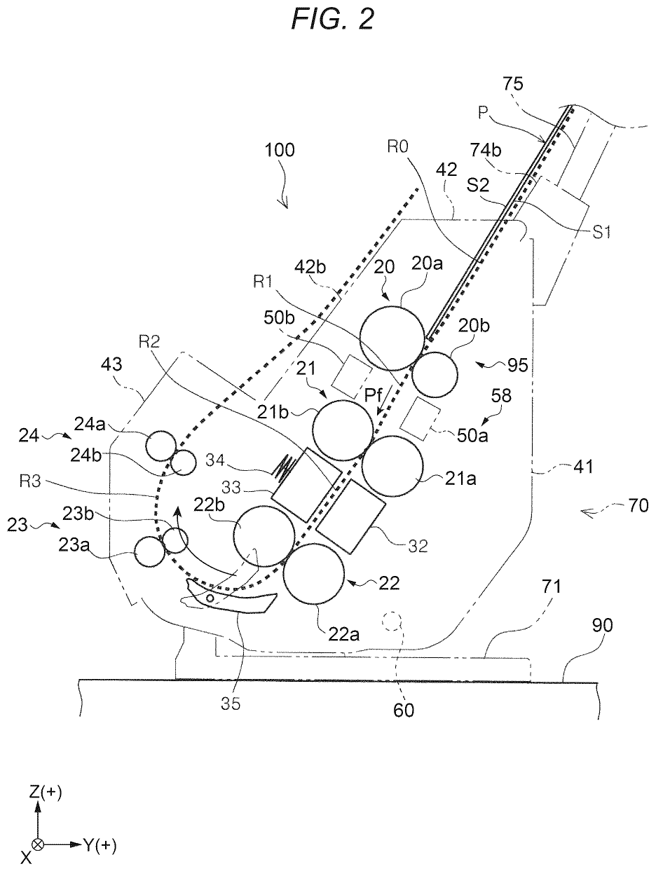

FIG. 1 is a front perspective view of a scanner according to Embodiment 1. FIG. 2 is a side sectional view showing a document transport route of the scanner. As below, embodiments of the present disclosure will be described with reference to the drawings.

A scanner 100 illustrated in FIGS. 1 and 2 is a so-called sheet-feed type scanner that reads a sheet-shaped medium P while moving the document with respect to a first reading unit 32 and a second reading unit 33, which will be described later. The scanner 100 is provided to read both a first surface S1 of the sheet-shaped medium P and a second surface S2 opposite thereto.

The drawings each show an X-axis, a Y-axis, and a Z-axis that are three axes orthogonal to one another. Directions along the X-axis are referred to as “X directions”, directions along the Y-axis are referred to as “Y directions”, and directions along the Z-axis are referred to as “Z directions”. As shown in FIG. 1, the scanner 100 has a horizontally long rectangular shape in a front view. In the embodiment, the width direction as the extension directions of the long side of the scanner 100 are the X direction, the depth direction is the Y direction, and the height direction is the Z direction. A direction in which the sheet-shaped medium P is transported is referred to as “downstream”, and a direction opposite to the downstream is referred to as “upstream”. In the drawings below, dimensions and scales different from actual values may be used for clarity of the description.

As shown in FIG. 2, the scanner 100 includes a main body 70 and a stand 71 that supports the main body 70. The stand 71 is placed on a placement surface 90. The placement surface 90 is, for example, a horizontal surface such as an upper surface of a desk.

The main body 70 includes a first unit 41, a second unit 42, and a third unit 43. The second unit 42 and the third unit 43 are provided to be rotatable with respect to the first unit 41 around a rotation shaft (not illustrated) parallel to the X-axis.

The second unit 42 and the third unit 43 are provided to be integrally rotatable around the rotation shaft with respect to the first unit 41. Specifically, the second unit 42 and the third unit 43 can be unlocked with respect to the first unit 41 by sliding a lock member 72 illustrated in FIG. 1 in the negative X direction. The lock member 72 is a sliding open/close button that switches between engagement and disengagement of the units.

The second unit 42 and the third unit 43 are rotated with respect to the first unit 41, and thus a part of the document transport route can be exposed. In particular, the second unit 42 is opened with respect to the first unit 41, and thus a supply route R0, a transport route R1, and a reading route R2, which will be described later, can be exposed.

The third unit 43 is provided to be rotatable around a rotation shaft (not illustrated) parallel to the X-axis with respect to the first unit 41 and the second unit 42. The third unit 43 is rotated with respect to the second unit 42, and thus a downstream ejection route R3 can be exposed from the reading route R2, which will be described later.

The third unit 43 is engaged with the second unit 42 by a snap-fit structure (not illustrated), and when a user applies an external force to the third unit 43, the engagement of the third unit 43 with the second unit 42 is released, and the third unit 43 can be opened.

The main body 70 is provided to be rotatable around a rotation shaft 60 with respect to the stand 71, and the main body 70 can take two attitudes by the rotation.

The attitude of the main body 70 illustrated in FIGS. 1 and 2 is one of the two attitudes, a normal reading attitude. The main body 70 can take a booklet reading attitude (not illustrated) as the other attitude by rotating from the normal reading attitude so that the reading route R2 may be horizontal. As shown in FIG. 1, an operation unit 73 is provided on the front surface of the main body 70. The operation unit 73 is provided with a plurality of operation buttons 73a to 73c. The operation buttons 73a to 73c are assigned with functions of a power button, a read button, and the like, and receive operations by the user.

### Document Transport Route

Next, a document transport route in the scanner 100 will be described with reference to FIG. 2. In FIG. 2, a thick broken line indicates a transport route in which the sheet-shaped medium P is transported.

The transport route is provided in the order of the supply route R0, the transport route R1, the reading route R2, and the ejection route R3 from the upstream side for transporting the sheet-shaped medium P from document support portions 75 to a front surface 42b of the second unit 42. The front surface 42b is an ejection tray. The sheet-shaped medium P includes a card-shaped document and a booklet-shaped document in addition to the sheet-shaped document.

The supply route R0 is the most upstream transport route before a first roller pair 20. The transport route R1 is a transport route between the first roller pair 20 and a second roller pair 21. The reading route R2 is a transport route between the second roller pair 21 and a third roller pair 22.

The first unit 41 forms lower parts of the supply route R0, the transport route R1, and the reading route R2. The second unit 42 forms upper parts of the supply route R0, the transport route R1, and the reading route R2. The ejection route R3 is formed between the second unit 42 and the third unit 43.

In the normal reading attitude illustrated in FIG. 2, the reading route R2 is coupled to the ejection route R3 by a flap 35. In the booklet reading attitude (not illustrated), the flap 35 is in an attitude indicated by a two-dot chain line, the reading route R2 is not coupled to the ejection route R3, and the sheet-shaped medium P is ejected from the reading route R2 in an obliquely downward direction (negative Y direction) in front of the main body 70.

The normal reading attitude is suitable for reading of the sheet-shaped sheet-shaped medium P, that is, a sheet-shaped medium P having lower rigidity and being easily bent. The booklet reading attitude is suitable for reading of a sheet-shaped medium P having higher rigidity and being hardly bent such as a plastic card or a booklet.

As illustrated in FIG. 2, the sheet-shaped medium P before reading is supported in an inclined attitude by a support portion 74b and the document support portions 75. The support portion 74b is a portion of an upper cover 74 in FIG. 1 being pivoted and stood. The upper cover 74 is provided to be rotatable around a rotation shaft (not illustrated), and opens and closes a feeding port of the sheet-shaped medium P by pivot.

As shown in FIG. 1, the document support portions 75 are housed in the upper cover 74 in the housed state with the upper cover 74 closed. When the upper cover 74 is opened, as indicated by dotted lines, the two document support portions 75 pivot and stand on the upper part of the main body 70, and can support the sheet-shaped medium P. The scanner 100 employs a so-called center feeding method, and the center position of the sheet-shaped medium P in the X direction, that is, the width direction matches regardless of the size of the sheet-shaped medium P. The upper cover 74 and the document support portions 75 are component portions of the first unit 41.

In FIG. 2, when a plurality of sheet-shaped media P are set on the document support portions 75, the uppermost sheet-shaped medium P is fed downstream by a roller 20a of the first roller pair 20. The first roller pair 20 includes the roller 20a as a driving roller and a roller 20b as a driven roller.

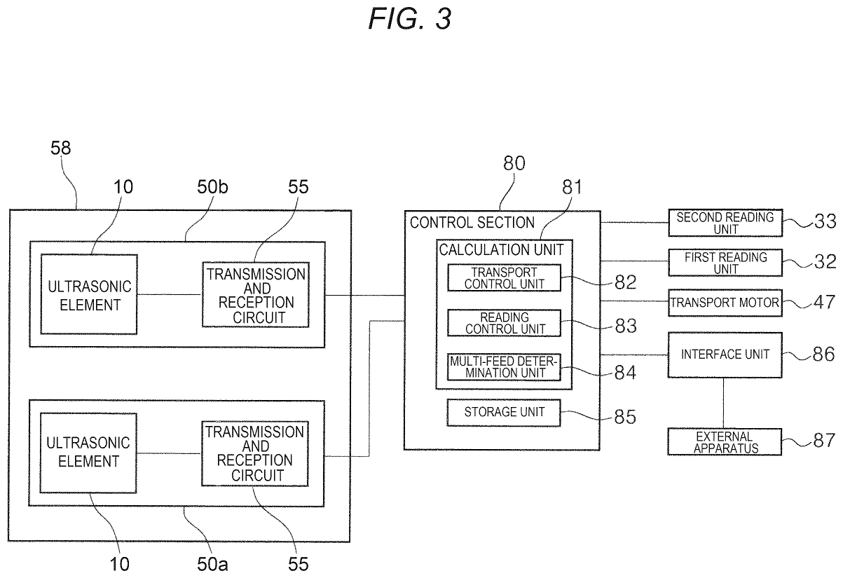

The roller 20a is provided in the second unit 42. The roller 20a is the driving roller that rotates by power from a transport motor 47 (FIG. 3).

The roller 20b is provided in the first unit 41. The roller 20b is provided to face the roller 20a via the supply route R0. A torque limiter (not illustrated) is attached to the roller 20b, and can suppress multi-feed of the sheet-shaped media P.

As illustrated in FIG. 2, the transport direction of the sheet-shaped medium P in the transport route R1 is a transport direction Pf. The configuration is not limited to the configuration in which the documents are fed from the uppermost sheet-shaped medium P, but the lower roller 20b may be a driving roller, the roller 20a may be a driven roller, and the documents may be fed from the lowermost sheet-shaped medium P.

A multi-feed detector 58 is provided in the transport route R1. The multi-feed detector 58 includes an ultrasonic device 50a and an ultrasonic device 50b disposed to face each other with the transport route R1 in between. The multi-feed detector 58 detects multi-feed of the sheet-shaped media P passing through the transport route R1. In a preferred example, the ultrasonic device 50a transmits ultrasonic waves and the ultrasonic device 50b receives the ultrasonic waves. In other words, the multi-feed detector 58 includes a pair of the ultrasonic device 50a for transmission and the ultrasonic device 50b for reception, the ultrasonic device 50a and the ultrasonic device 50b are disposed with the transport route R1 as the transport route for the sheet-shaped medium P in between, transmits ultrasonic waves from the ultrasonic device 50a, receives the ultrasonic waves passing through the medium P by the ultrasonic device 50b, and detects the multi-feed of the medium P based on the intensity of a reception signal. The details of the ultrasonic devices 50a and 50b will be described later.

Further, a configuration including a transport route including at least the supply route R0 and the transport route R1, and the multi-feed detector 58 is referred to as a transport device 95. In other words, the transport device 95 includes the multi-feed detector 58.

The second roller pair 21 is provided downstream of the first roller pair 20.

The second roller pair 21 includes a roller 21a provided in the first unit 41 and a roller 21b provided in the second unit 42. The roller 21b is provided to be movable toward and away from the roller 21a, and is pressed toward the roller 21a by a pressing member (not illustrated), for example, a coil spring. Accordingly, the roller 21b moves toward and away from the roller 21a according to the thickness of the transported sheet-shaped medium P. Both the roller 21a and the roller 21b rotate by power from the transport motor 47 (FIG. 3).

When the second unit 42 is closed with respect to the first unit 41, the roller 21a and the roller 21b come into contact with each other. When the second unit 42 is opened with respect to the first unit 41, the roller 21b is separated from the roller 21a.

The first reading unit 32 and the second reading unit 33 are disposed to face each other downstream of the second roller pair 21. The first reading unit 32 is provided in the first unit 41, and the second reading unit 33 is provided in the second unit 42.

The first reading unit 32 reads the first surface S1 of the sheet-shaped medium P, and the second reading unit 33 reads the second surface S2 opposite to the first surface S1 of the sheet-shaped medium P. The second reading unit 33 is provided to be movable toward and away from the first reading unit 32, and is pressed toward the first reading unit 32 by a pressing spring 34 which is an example of a pressing member. Accordingly, the second reading unit 33 moves toward and away from the first reading unit 32 according to the thickness of the transported sheet-shaped medium P. In the embodiment, the first reading unit 32 and the second reading unit 33 are configured with contact image sensor modules (CISMs). In other words, the scanner 100 includes the transport device 95, and the first reading unit 32 and the second reading unit 33 as reading units that read an image printed on the medium P.

The third roller pair 22 is provided downstream of the first reading unit 32 and the second reading unit 33. The third roller pair 22 includes a roller 22a provided in the first unit 41 and a roller 22b provided in the second unit 42. The roller 22b is provided to be movable toward and away from the roller 22a, and is pressed toward the roller 22a by a pressing member (not illustrated), for example, a coil spring. Both the roller 22a and the roller 22b rotate by power from the transport motor 47 (FIG. 3).

When the second unit 42 is closed with respect to the first unit 41, the roller 22a and the roller 22b come into contact with each other. When the second unit 42 is opened with respect to the first unit 41, the roller 22b is separated from the roller 22a. When the second unit 42 is opened, the first reading unit 32 and the second reading unit 33 are exposed, and thus cleaning can be performed. At the same time, the ultrasonic device 50a and the ultrasonic device 50b are also exposed together, cleaning can be performed together. It is preferable to remove the foreign matter by air blowing when the contamination is minor, and to perform cleaning with a cleaning liquid when the contamination is fixed.

The flap 35 is provided downstream of the third roller pair 22. The flap 35 pivots to switch between the above described two document transport routes. In the embodiment, the flap 35 is configured to rotate in conjunction with the attitude switching of the main body 70. As the configuration of rotating the flap 35 in conjunction with the attitude switching of the main body 70, a configuration of mechanically rotating the flap in conjunction with the attitude of the main body 70 by an interlocking mechanism (not illustrated), for example, a cam mechanism is adopted. The configuration is not limited to that, but the flap 35 may be configured to be rotated by a solenoid (not illustrated).

The ejection route R3 is also referred to as a U-turn route because the sheet-shaped medium P transported in the negative Z direction is caused to make a U-turn along the flap 35 and ejected in the positive Z direction.

A fourth roller pair 23 and a fifth roller pair 24 are provided in the ejection route R3. The fourth roller pair 23 includes a roller 23a provided in the third unit 43 and a roller 23b provided in the second unit 42. The roller 23b is provided to be movable toward and away from the roller 23a, and is pressed toward the roller 23a by a pressing member (not illustrated), for example, a coil spring.

Accordingly, the roller 23b moves toward and away from the roller 23a according to the thickness of the transported sheet-shaped medium P. The roller 23a is a driving roller driven by the transport motor 47 (FIG. 3). The roller 23b is a driven roller.

The fifth roller pair 24 includes a roller 24a provided in the third unit 43 and a roller 24b provided in the second unit 42. The roller 24b is provided to be movable toward and away from the roller 24a, and is pressed toward the roller 24a by a pressing member (not illustrated), for example, a coil spring.

Accordingly, the roller 24b moves toward and away from the roller 24a according to the thickness of the transported sheet-shaped medium P. The roller 24a is a driving roller driven by the transport motor 47 (FIG. 3). The roller 24b is a driven roller.

When the third unit 43 is closed with respect to the second unit 42, the roller 23a and the roller 23b come into contact with each other. Similarly, the roller 24a and the roller 24b come into contact with each other.

When the third unit 43 is opened with respect to the second unit 42, the roller 23a and the roller 23b are separated from each other. Similarly, the roller 24a and the roller 24b are separated from each other.

The sheet-shaped medium P passing through the ejection route R3 is ejected in the positive Z direction by the fifth roller pair 24, and is supported in an inclined attitude by the front surface 42b of the second unit 42.

### Control Block Configuration

FIG. 3 is a block configuration diagram showing a control system of the scanner.

Next, the control system of the scanner 100 will be described with reference to FIG. 3.

A control section 80 includes a calculation unit 81 including one or more processors, and a storage unit 85 including a nonvolatile memory and a volatile memory.

The first reading unit 32, the second reading unit 33, the transport motor 47, and the multi-feed detector 58 are coupled to the control section 80, and the control section 80 performs integrated control thereof.

The transport motor 47 is a drive source for the roller 20a, the rollers 21a and 21b, the rollers 22a and 22b, the roller 23a, and the roller 24a. Although individual drive motors are actually provided for the respective rollers, the drive motors are illustrated as the same functional block in FIG. 3.

The control section 80 is coupled to an interface unit 86, and can receive various data and signals input from an external apparatus 87 such as a personal computer and output read data read by the scanner 100 to the external apparatus 87.

Various data and various programs for controlling the scanner 100 are recorded in the storage unit 85.

The calculation unit 81 functions as a transport control unit 82, a reading control unit 83, a multi-feed determination unit 84, and the like by reading and executing the various programs stored in the storage unit 85.

The transport control unit 82 controls the transport motor 47 to rotate the above described plurality of rollers, thereby feeding, transporting, and ejecting the sheet-shaped medium P.

The reading control unit 83 controls the first reading unit 32 and the second reading unit 33 during the transport of the sheet-shaped medium P to read the image of the sheet-shaped medium P.

The multi-feed determination unit 84 is a state detection unit that detects the state of the sheet-shaped medium P, and determines multi-feed of the sheet-shaped medium P based on a reception signal input from a transmission and reception circuit 55 of the multi-feed detector 58. In a preferred example, the transmission and reception circuit 55 is provided to switch between a transmission circuit and a reception circuit of ultrasonic waves. The transmission and reception circuit 55 functions as a transmission circuit that transmits ultrasonic waves in the ultrasonic device 50a, and transmits ultrasonic waves having a frequency in response to a drive signal from an ultrasonic element 10. The transmission and reception circuit 55 functions as a reception circuit that receives ultrasonic waves in the ultrasonic device 50b, and detects a signal level of the ultrasonic waves entering the ultrasonic element 10. A dedicated transmission circuit and a dedicated reception circuit may be provided. When the voltage value of the reception signal of the ultrasonic device 50b is smaller than a predetermined threshold value, the multi-feed determination unit 84 determines that the sheet-shaped media P are multi-fed. When the multi-feed determination unit 84 determines that multi-feed occurs, the transport control unit 82 stops transporting the sheet-shaped medium P.

### Configuration of Multi-Feed Detector

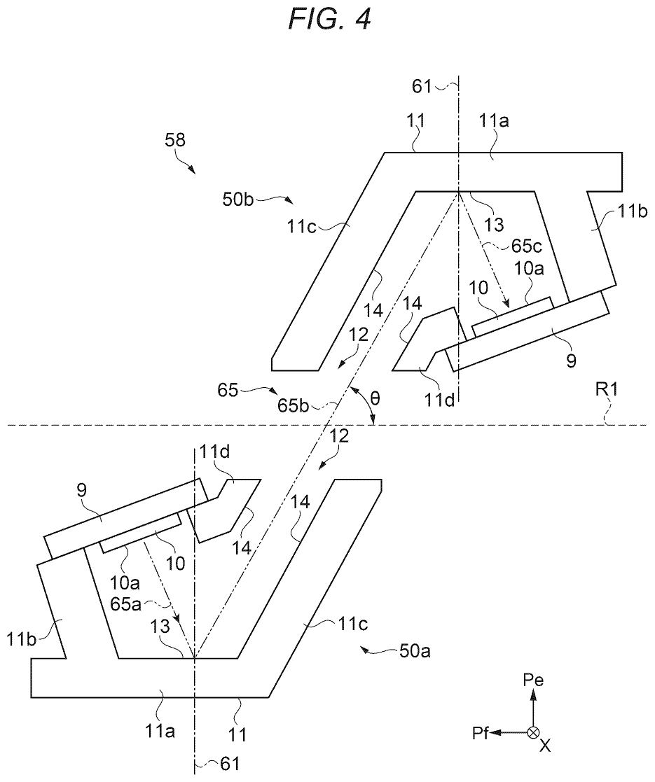

FIG. 4 is a side sectional view showing a configuration of the multi-feed detector. FIG. 4 illustrates a side cross section of main parts of the ultrasonic device 50a and the ultrasonic device 50b disposed to face each other via the transport route R1. In FIG. 4, as three axes orthogonal to one another, an X-axis, the transport direction Pf of the sheet-shaped medium P, and a perpendicular direction Pe orthogonal to the transport direction pf are coordinate axes.

As illustrated in FIG. 4, the ultrasonic waves emitted from the ultrasonic element 10 of the ultrasonic device 50a are reflected by a reflection surface 13 of a housing 11, pass through a waveguide 14, are emitted from an opening 12, and enter the ultrasonic device 50b via the transport route R1. In a preferred example, the ultrasonic device 50b has the same configuration as the ultrasonic device 50a, and the ultrasonic waves passing through the transport route R1 enter from the opening 12 of the ultrasonic device 50b, pass through the waveguide 14, are reflected by the reflection surface 13, and enter the ultrasonic element 10 at the reception side. In this regard, an emitted ultrasonic beam is transmitted around a center axis 65. Specifically, the ultrasonic waves are emitted from the ultrasonic element 10 around a center axis 65a, are reflected by the reflection surface 13, travel around a center axis 65b, are reflected by the reflection surface 13 at the reception side, travel around a center axis 65c, and enter the ultrasonic element 10 at the reception side. The center axes 65a to 65c are also collectively referred to as the center axis 65.

Here, the center axis 65b as a first axis is inclined at an angle θ with respect to the transport route R1. The angle θ in a preferred example is about 70°. The angle θ is not limited thereto, but may be from 60° to 80°. As described above, the center axis 65b of the ultrasonic beam is inclined with respect to the transport route R1, and thus multiple reflection of the ultrasonic waves between the sheet-shaped medium P and the ultrasonic element 10 for transmission can be suppressed. Specifically, when the center axis 65 is aligned with the perpendicular direction of the sheet-shaped medium P, that is, when the angle θ=90°, the ultrasonic waves emitted from the ultrasonic element 10 may be multiply reflected between the sheet-shaped medium P and the ultrasonic element 10. In other words, the center axis 65b as the first axis is inclined with respect to a perpendicular line of the sheet-shaped medium P as an irradiated object irradiated with the ultrasonic waves.

### Configuration of Ultrasonic Device

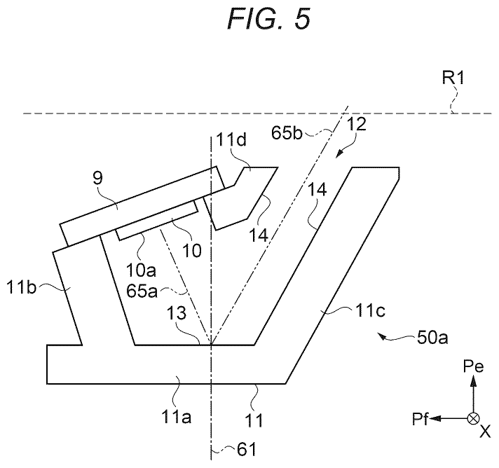

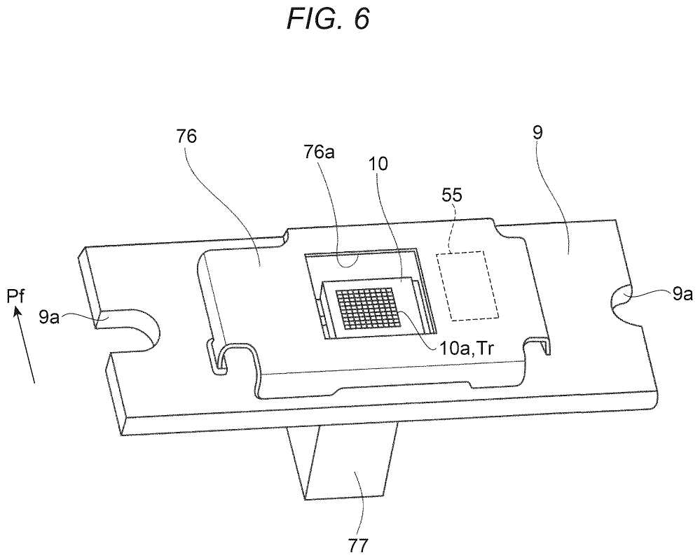

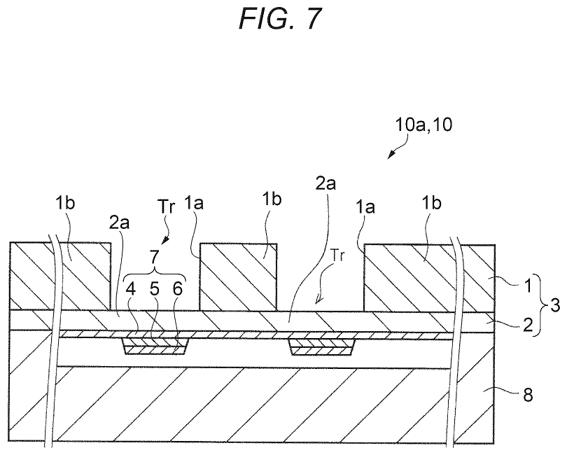

FIG. 5 is a side sectional view showing a configuration of the ultrasonic device, and is an enlarged view of the ultrasonic device 50a in FIG. 4. FIG. 6 is a perspective view of a main board. FIG. 7 is a side sectional view of a main part of the ultrasonic element. Here, the configurations of the ultrasonic devices 50a and 50b will be described using the ultrasonic device 50a as a representative. As described above, the ultrasonic device 50b has the same configuration as the ultrasonic device 50a, and only the placement attitude is different.

As shown in FIG. 5, the ultrasonic device 50a includes the housing 11, a main board 9, the ultrasonic element 10, and the like.

The housing 11 is a case that houses the ultrasonic element 10. As illustrated in FIG. 5, the housing 11 includes a base portion 11a as a plate-shaped portion substantially parallel to the transport route R1, a first wall lib extending from the base portion 11a along the center axis 65a, a second wall 11c extending from the base portion 11a along the center axis 65b, a third wall 11d facing the second wall 11c, and the like. The first wall 11b and the second wall 11c are provided so as to open in a V-shape from the base portion 11a.

The inner surface of the base portion 11a is the flat reflection surface 13. A perpendicular line of the reflection surface 13 is a center line 61.

The opening 12 is formed at the ends of the second wall 11c and the third wall 11d. The opening 12 has a rectangular shape in a plan view from the transport route R1 side. The inner surfaces of the second wall 11c and the third wall 11d are the waveguides 14. The center axis 65b passes through the center of the waveguides 14. In other words, the waveguide 14 extends along the center axis 65b as the first axis.

The housing 11 may be formed using metal or resin. When the housing 11 is formed using metal, a shielding effect of protecting the ultrasonic element 10 from the influence of static electricity or electromagnetic waves is obtained. When the housing 11 is formed using resin, the housing 11 can be efficiently formed by injection molding. For example, in the housing 11 of the embodiment, when the housing 11 has a resin two-part configuration including a plate-shaped portion including the base portion 11a from which the reflection surface 13 extends and a portion including the first wall lib, the second wall 11c, and the third wall 11d, molding efficiency is higher.

The main board 9 is attached between the end of the first wall lib and the end of the third wall 11d. The ultrasonic element 10 is mounted on the main board 9. The surface of the ultrasonic element 10 is referred to as a transmission and reception surface 10a.

As shown in FIG. 6, the main board 9 is a rectangular board. Both short sides of the main board 9 are provided with cutout holes 9a for fastening by screws.

The ultrasonic element 10, the transmission and reception circuit 55, a cover member 76, and the like are mounted on the surface of the main board 9. The ultrasonic element 10 is a component having a rectangular shape in the plan view.

As illustrated in FIG. 7, the ultrasonic element 10 has a configuration in which an element substrate 3 is stacked on a base substrate 8. The base substrate 8 is a mounting substrate and includes a plurality of terminals (not illustrated) on a lower surface thereof. The element substrate 3 includes a semiconductor substrate 1, a diaphragm 2, and the like.

In a preferred example, the semiconductor substrate 1 is a silicon substrate. The substrate is not limited to a silicon substrate, but may be any semiconductor substrate. The semiconductor substrate 1 is provided with openings 1a as a plurality of through holes in a grid pattern. The walls defining the plurality of openings 1a are referred to as partition walls 1b.

In a preferred example, the diaphragm 2 is formed using a layered structure in which a plurality of SiO₂ films are stacked. The diaphragm 2 is not limited thereto, but may be formed using a layered structure in which SiO₂ films and ZrO₂ films are alternately stacked to form a plurality of layers. The diaphragm 2 is provided on the surface of the semiconductor substrate 1 at the base substrate 8 side to close the plurality of openings 1a.

A vibrator portion 7 is formed in a part overlapping the opening 1a in the diaphragm 2. The vibrator portion 7 is formed by stacking of a first electrode 4, a piezoelectric element 5, and a second electrode 6 in this order on the diaphragm 2. The first electrode 4 is a solid electrode and is provided to cover all the openings 1a and the partition walls 1b. The piezoelectric element 5 is selectively provided in portions overlapping the openings 1a. In a preferred example, zinc zirconate titanate (PZT) is used for the piezoelectric element 5, but the element is not limited thereto. The second electrode 6 is provided, for example, in a stripe shape along the extension direction of the short side of the main board 9. A space is provided between the vibrator portion 7 and the base substrate 8 so as not to hinder the vibration of the vibrator portion 7.

As shown in FIG. 7, one ultrasonic transducer Tr includes the vibrator portion 7 provided in the opening portion u1a. As shown in FIG. 6, a plurality of ultrasonic transducers Tr are provided in a matrix on the transmission and reception surface 10a of the ultrasonic element 10. The ultrasonic transducer Tr is electrically coupled to the transmission and reception circuit 55.

The metal cover member 76 is provided on the surface of the main board 9 to cover the ultrasonic element 10 and the transmission and reception circuit 55. The cover member 76 is provided with an opening 76a that exposes the transmission and reception surface 10a of the ultrasonic element 10. A power supply potential such as GND is supplied to the cover member 76 to protect the ultrasonic element 10 and the transmission and reception circuit 55 from static electricity and electromagnetic waves. The cover member 76 is not essential, and the cover member 76 may not be provided when the housing 11 is made of metal and has a shielding property.

A connector 77 is mounted on the back surface of the main board 9. A cable (not illustrated) is coupled to the connector 77 and is electrically coupled to the control section 80 (FIG. 3).

FIG. 5 shows a cross section in the short-side direction of the main board 9. The main board 9 is fastened by screws to the housing 11 using the two cutout holes 9a (FIG. 6) provided at the front and back sides in the depth direction (X direction).

As shown in FIG. 5, the reflection surface 13 is provided on the center axis 65a as a perpendicular line of the transmission and reception surface 10a of the ultrasonic element 10. The center axis 65a is inclined with respect to the center line 61 as the perpendicular line of the reflection surface 13. The center axis 65b as the first axis is inclined in a direction different from that of the center axis 65a with respect to the center line 61 as the perpendicular line of the reflection surface 13.

In other words, the ultrasonic element 10 has the transmission and reception surface 10a of ultrasonic waves, and the reflection surface 13 is provided on the center axis 65a as the perpendicular line of the transmission and reception surface 10a. The center axis 65a as the perpendicular line of the transmission and reception surface 10a is inclined with respect to the center line 61 as the perpendicular line of the reflection surface 13. The center axis 65b as the first axis is inclined in a direction different from that of the center axis 65a as the perpendicular line of the transmission and reception surface 10a with respect to the center line 61 as the perpendicular line of the reflection surface 13. The ultrasonic device 50a includes the ultrasonic element 10 that performs at least one of transmission of ultrasonic waves and reception of ultrasonic waves, and the housing 11 that houses the ultrasonic element 10, and the housing 11 includes the reflection surface 13 that reflects the ultrasonic waves, the waveguide 14 through which the ultrasonic waves propagate, and the opening 12 that is provided at one end of the waveguide 14 and through which the ultrasonic waves pass.

As described above, according to an ultrasonic device 50, the multi-feed detector 58, the transport device 95, and the scanner 100 of the embodiment, the following effects can be obtained.

The ultrasonic device 50 includes the ultrasonic element 10 that performs at least one of transmission of ultrasonic waves and reception of ultrasonic waves, and the housing 11 that houses the ultrasonic element 10, and the housing 11 has the reflection surface 13 that reflects the ultrasonic waves, the waveguide 14 through which the ultrasonic waves propagate, and the opening 12 that is provided at one end of the waveguide 14 and through which the ultrasonic waves pass.

For example, in a case where the ultrasonic device 50 is the ultrasonic device 50a at the transmission side, even when foreign matter enters from the opening 12, the foreign matter remains on the reflection surface 13, and adhesion of the foreign matter to the transmission and reception surface 10a of the ultrasonic element 10 can be suppressed. Accordingly, the reception sensitivity of ultrasonic waves can be secured. The foreign matter on the reflection surface 13 can be cleaned by air blowing. The same applies to the ultrasonic device 50b.

Therefore, the ultrasonic device 50 that is easily cleaned and has stable ultrasonic transmission and reception sensitivity can be provided.

Further, the ultrasonic element 10 has the transmission and reception surface 10a of ultrasonic waves, and the reflection surface 13 is provided on the center axis 65a as the perpendicular line of the transmission and reception surface 10a.

According to the configuration, the ultrasonic waves emitted from the ultrasonic element 10 at the transmission side travel along the center axis 65a, are then reflected by the reflection surface 13, and travel along the center axis 65b. Also, at the reception side, the ultrasonic waves entering along the center axis 65b are reflected by the reflection surface 13, travel along the center axis 65c, and enter the ultrasonic element 10 at the reception side. Therefore, stable transmission and reception sensitivity can be obtained by appropriate reflection of ultrasonic waves.

The center axis 65a as the perpendicular line of the transmission and reception surface 10a is inclined with respect to the center line 61 as the perpendicular line of the reflection surface 13. According to the configuration, the ultrasonic waves can be appropriately reflected.

The waveguide 14 extends along the center axis 65b as the first axis, and the center axis 65b is inclined in a direction different from that of the center axis 65a as the perpendicular line of the transmission and reception surface 10a with respect to the center line 61 as the perpendicular line of the reflection surface 13. Therefore, stable transmission and reception sensitivity can be obtained by appropriate reflection of ultrasonic waves.

Further, the center axis 65b as the first axis is inclined with respect to the perpendicular line of the sheet-shaped medium P as the irradiated object irradiated with the ultrasonic waves.

According to the configuration, multiple reflection of ultrasonic waves between the sheet-shaped medium P and the ultrasonic element 10 for transmission can be suppressed.

The multi-feed detector 58 includes the pair of the ultrasonic device 50a for transmission and the ultrasonic device 50b for reception, the ultrasonic device 50a and the ultrasonic device 50b are disposed with the transport route R1 as the transport route of the sheet-shaped medium P in between, ultrasonic waves are transmitted from the ultrasonic device 50a, the ultrasonic waves passing through the medium P are received by the ultrasonic device 50b, and multi-feed of the medium P is detected based on the intensity of the reception signal.

According to the configuration, the multi-feed detector 58 includes the ultrasonic device 50a for transmission and the ultrasonic device 50b for reception, which are easily cleaned and have stable ultrasonic transmission and reception sensitivity.

Therefore, the multi-feed detector 58 that is easily cleaned and has stable ultrasonic transmission and reception sensitivity can be provided.

The transport device 95 includes the multi-feed detector 58.

According to the configuration, the transport device 95 including the multi-feed detector 58 that is easily cleaned and has stable ultrasonic transmission and reception sensitivity can be provided.

The scanner 100 includes the transport device 95, and the first reading unit 32 and the second reading unit 33 as the reading units that read an image printed on the medium P.

According to the configuration, the scanner 100 including the multi-feed detector 58 that is easily cleaned and has stable ultrasonic transmission and reception sensitivity can be provided.

### Embodiment 2

### Different Configuration of Ultrasonic Device-1

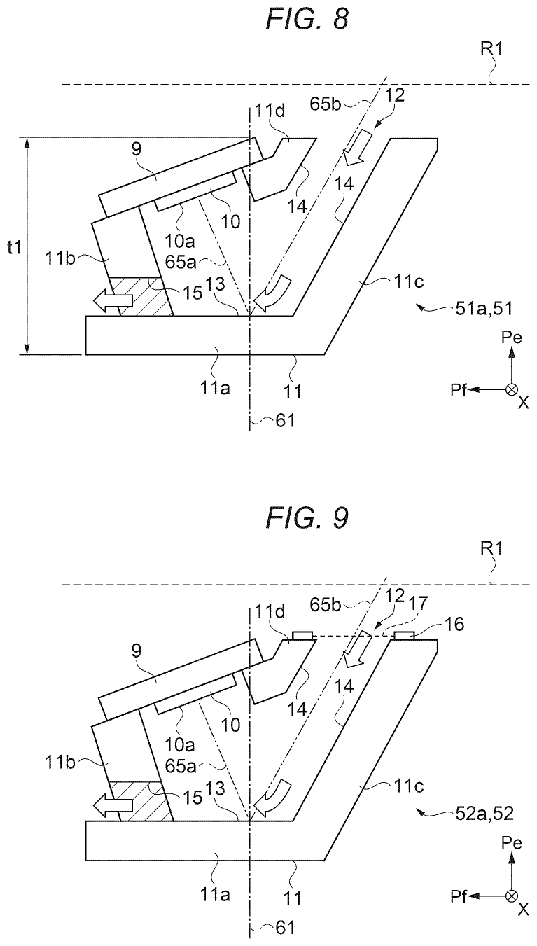

FIG. 8 is a side sectional view showing a configuration of an ultrasonic device according to Embodiment 2, and corresponds to FIG. 5.

The ultrasonic device 50 of the above described embodiment may include an ejection hole 15 for ejecting the foreign matter entering the housing 11. Hereinafter, the same parts as those of the above described embodiment have the same signs, and the overlapping description will be omitted.

As shown in FIG. 8, an ultrasonic device 51 of the embodiment includes the ejection hole 15 for ejecting foreign matter entering the housing 11. Except for that, the configuration is the same as that of the above described ultrasonic device 50. The ejection hole 15 is a through hole penetrating the first wall 11b, and is provided in a portion of the first wall 11b facing the reflection surface 13. In a preferred example, the ejection hole 15 is provided horizontally long in the X direction along the reflection surface 13. In other words, the housing 11 has the ejection hole 15 at a position different from that of the opening 12. In FIG. 8, an ultrasonic device 51b for reception is not illustrated, but has the same configuration as an ultrasonic device 51a.

Foreign matter entering from the opening 12 is likely to adhere to the waveguide 14 and the reflection surface 13. According to the ultrasonic device 51 of the embodiment, air is blown toward the opening 12 by an air duster (not illustrated), and thus the foreign matter adhering to the waveguide 14 and the reflection surface 13 can be ejected from the ejection hole 15 as indicated by open arrows. Note that the ejection hole 15 provided not limited at the above described position, but may be provided at a position where foreign matter on the waveguide 14 and the reflection surface 13 can be ejected by the air flow from the opening 12.

As described above, according to the ultrasonic device 51 of the embodiment, the following effects can be obtained in addition to the effects according to the above described embodiment.

The housing 11 of the ultrasonic device 51 has the ejection hole 15 at the position different from that of the opening 12.

According to the configuration, air is blown toward the opening 12, and thus the foreign matter adhering to the waveguide 14 and the reflection surface 13 can be easily ejected from the ejection hole 15.

Therefore, the ultrasonic device 51 that is easily cleaned and has stable ultrasonic transmission and reception sensitivity can be provided.

### Embodiment 3

### Different Configuration of Ultrasonic Device-2

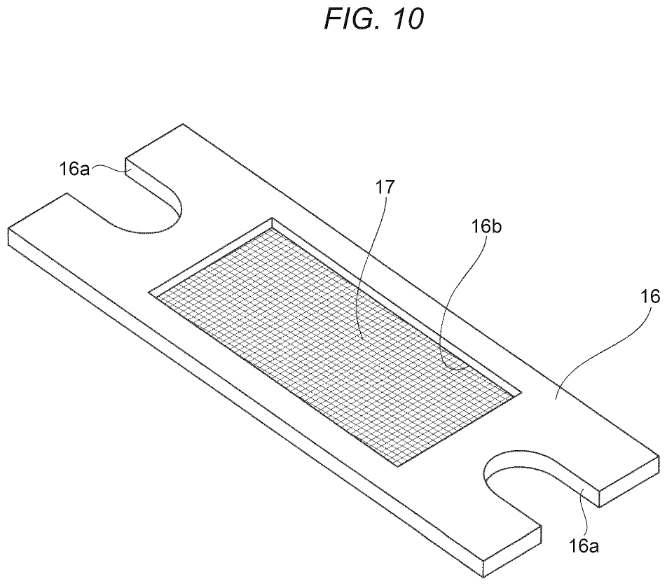

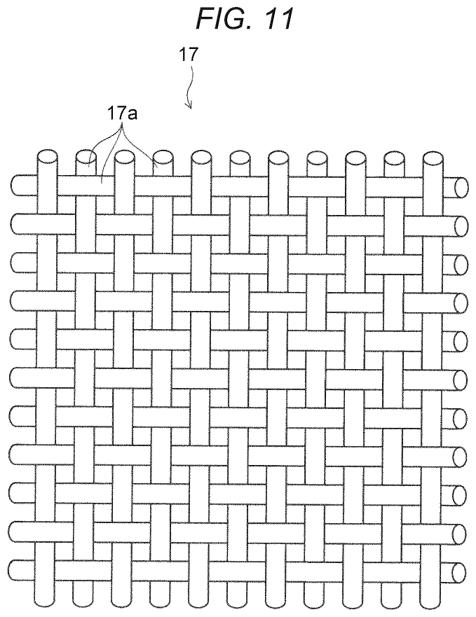

FIG. 9 is a side sectional view showing a configuration of an ultrasonic device according to Embodiment 3, and corresponds to FIG. 8. FIG. 10 is a perspective view of a protector. FIG. 11 is an enlarged view of the protector.

In the ultrasonic device 51 of the above described embodiment, a mesh-like protector 17 may be provided in the opening 12. Hereinafter, the same parts as those of the above described embodiment have the same signs, and the overlapping description will be omitted.

As shown in FIG. 9, an ultrasonic device 52 of the embodiment includes the mesh-like protector 17 in the opening 12. Except for that, the configuration is the same as that of the above described ultrasonic device 50.

As shown in FIG. 10, the protector 17 is attached to a support frame 16. The support frame 16 is a rectangular resin frame and has a rectangular opening 16b. The opening 16b is set to be slightly larger than the opening 12 of the ultrasonic device 52. The protector 17 is attached to the opening 16b of the support frame 16. In other words, the mesh-like protector 17 is provided in the opening 12 of the ultrasonic device 52.

Both short sides of the support frame 16 are provided with cutout holes 16a for fastening by screws. In FIG. 9, the support frame 16 is fastened by screws to the housing 11 using the two cutout holes 16a (FIG. 10) provided at the front and back sides in the depth direction (X direction).

As shown in FIG. 11, the protector 17 is a filter formed in a mesh shape by arrangement of wires 17a in an intersecting manner. FIG. 11 shows an example in which the wires 17a are orthogonal to each other, but not limited thereto. Any configuration may be used as long as the wires 17a intersect each other. In a preferred example, polyester is used as for the wire 17a. The material is not limited to polyester, but metal materials or alloy materials such as copper, iron, brass, and SUS, synthetic resins such as nylon and polyester, and the like may be used.

Since the ultrasonic device 52 includes the ejection hole 15, fine foreign matter can be easily cleaned by air blowing. Therefore, the protector 17 is required to have a function of preventing entry of large-sized foreign matter such as eraser shavings attached to the medium P, for example. For this reason, the protector 17 is set to be rough to such an extent that clogging or sticking of paper dust does not occur even when cleaned with a cleaning liquid.

As described above, according to the ultrasonic device 52 of the embodiment, the following effects can be obtained in addition to the effects according to the above described embodiments.

Th mesh-like protector 17 is provided in the opening 12 of the ultrasonic device 52.

According to the configuration, entry of large-sized foreign matter into the housing 11 can be prevented, and the foreign matter adhering to the waveguide 14 and the reflection surface 13 can be ejected from the ejection hole 15 by blowing of air toward the opening 12. Further, even when the protector 17 is cleaned with a cleaning liquid, clogging and sticking of paper dust can be prevented.

Therefore, the ultrasonic device 52 that is easily cleaned and has stable ultrasonic transmission and reception sensitivity can be provided.

### Embodiment 4

### Different Configuration of Ultrasonic Device-3

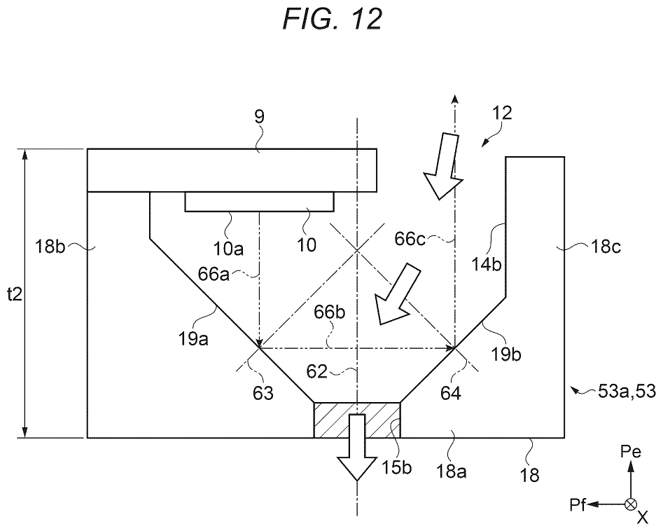

FIG. 12 is a side sectional view showing a configuration of an ultrasonic device according to Embodiment 4, and corresponds to FIG. 8.

In the above described embodiment, the reflection surface 13 of the ultrasonic device 51 is provided at one position, however, a plurality of reflection surfaces may be provided. Hereinafter, the same parts as those of the above described embodiment have the same signs, and the overlapping description will be omitted.

An ultrasonic device 53 of the embodiment includes two reflection surfaces of a first reflection surface 19a and a second reflection surface 19b inside a housing 18.

As shown in FIG. 12, the housing 18 of the ultrasonic device 53 has a rectangular shape in a side view. A bottom portion 18a is provided along one long side of the housing 18. The bottom portion 18a is provided with an ejection hole 15b. The center line of the ejection hole 15b is a center line 62.

A first wall 18b is provided along one short side of the housing 18. One end of the main board 9 is fixed on the first wall 18b. The back surface of the main board 9 is the other long side of the housing 18. A second wall 18c is provided along the other short side of the housing 18.

The opening 12 is formed between the other end of the main board 9 and the second wall 18c.

Inside the housing 18, the inclined first reflection surface 19a is provided between the first wall 18b and the bottom portion 18a. The inclined second reflection surface 19b is provided between the second wall 18c and the bottom portion 18a. The first reflection surface 19a is provided on a center axis 66a as the perpendicular line of the transmission and reception surface 10a of the ultrasonic element 10. A center line 63 as a perpendicular line of the first reflection surface 19a is inclined with respect to the center axis 66a. A center line 64 as a perpendicular line of the second reflection surface 19b intersects the center line 63 of the first reflection surface 19a.

The ejection hole 15b is provided between the first reflection surface 19a and the second reflection surface 19b. The first reflection surface 19a and the second reflection surface 19b are provided in line symmetry with respect to the center line 62 of the ejection hole 15b as the center of symmetry.

According to the configuration, as shown in FIG. 12, ultrasonic waves emitted from the ultrasonic element 10 of an ultrasonic device 53a are reflected by the first reflection surface 19a, are further reflected by the second reflection surface 19b, and are emitted from the opening 12. Specifically, the ultrasonic waves are emitted from the ultrasonic element 10 around the center axis 66a, are then reflected by the first reflection surface 19a, travel around a center axis 66b, are reflected by the second reflection surface 19b, travel around a center axis 66c, and are emitted from the opening 12. In the housing 18, a portion along the inner wall of the second wall 18c serves as a waveguide 14b. In an ultrasonic device 53b for reception, the ultrasonic waves enter the ultrasonic element 10 in a route reversed thereto. The housing 18 can be formed of the same material as the housing 11.

In other words, the housing 18 has the first reflection surface 19a and the second reflection surface 19b as the reflection surfaces, the first reflection surface 19a is provided on the center axis 66a as the perpendicular line of the transmission and reception surface 10a of the ultrasonic element 10, the center line 63 as the perpendicular line of the first reflection surface 19a is inclined with respect to the center axis 66a, and the center line 64 as the perpendicular line of the second reflection surface 19b intersects the center line 63 of the first reflection surface 19a. Further, the ejection hole 15b is provided between the first reflection surface 19a and the second reflection surface 19b in the housing 18, and the first reflection surface 19a and the second reflection surface 19b are provided in line symmetry with respect to the center line 62 of the ejection hole 15b as the center of symmetry.

Foreign matter entering from the opening 12 is likely to adhere to the waveguide 14b, the first reflection surface 19a, and the second reflection surface 19b.

According to the ultrasonic device 53 of the embodiment, air is blown toward the opening 12 by an air duster (not illustrated), and thus the foreign matter adhering to the waveguide 14b, the first reflection surface 19a, and the second reflection surface 19b can be ejected from the ejection hole 15b as indicated by open arrows.

Further, according to the ultrasonic device 53, the housing 18 can have a low-profile configuration. Specifically, as shown in FIG. 12, since the two reflection surfaces are provided, the main board 9 can be disposed along the long side of the housing 18, and thus the housing 18 having a compact configuration can be implemented. Accordingly, a height t2 of the housing 18 can be made smaller than a height t1 of the housing 11 in FIG. 8, and a more compact configuration can be achieved.

As described above, according to the ultrasonic device 53 of the embodiment, the following effects can be obtained in addition to the effects according to the above described embodiments.

The housing 18 of the ultrasonic device 53 has the first reflection surface 19a and the second reflection surface 19b as the reflection surfaces, the first reflection surface 19a is provided on the center axis 66a as the perpendicular line of the transmission and reception surface 10a of the ultrasonic element 10, the center line 63 as the perpendicular line of the first reflection surface 19a is inclined with respect to the center axis 66a, and the center line 64 as the perpendicular line of the second reflection surface 19b intersects the center line 63 of the first reflection surface 19a.

According to the configuration, since the two reflection surfaces are provided, the main board 9 can be disposed along the long side of the housing 18, and thus the compact ultrasonic device 53 can be provided. Further, since the transmission and reception surface 10a of the ultrasonic element 10 does not face the opening 12, the adhesion of foreign matter to the transmission and reception surface 10a can be suppressed.

Therefore, the ultrasonic device 53 that is easily cleaned and has stable ultrasonic transmission and reception sensitivity can be provided.

Further, the ejection hole 15b is provided between the first reflection surface 19a and the second reflection surface 19b in the housing 18, and the first reflection surface 19a and the second reflection surface 19b are provided in line symmetry with respect to the center line 62 of the ejection hole 15b as the center of symmetry.

According to the configuration, air is blown toward the opening 12, and thus the foreign matter adhering to the waveguide 14b, the first reflection surface 19a, and the second reflection surface 19b can be easily ejected from the ejection hole 15b.

Therefore, the ultrasonic device 53 that is easily cleaned and has stable ultrasonic transmission and reception sensitivity can be provided.

### Modifications

In the above description, the scanner 100 is exemplified as an example of an electronic apparatus, however, the present disclosure can be applied to an electronic apparatus having a function of transporting media one by one. For example, in a printing apparatus (printer) including a printing head that prints an image on a sheet transported on a transport route, the multi-feed detector using the above described ultrasonic device 50, 51, 52, or 53 may be applied for detection of multi-feed of sheets. According to the configurations, the same functions and effects as those of the above described embodiments can be obtained.

What is claimed is:

1. An ultrasonic device comprising:
an ultrasonic element that performs at least one of transmission of ultrasonic waves and reception of ultrasonic waves; and
a housing that houses the ultrasonic element, wherein
the housing includes
a reflection surface that reflects the ultrasonic waves,
a waveguide through which the ultrasonic waves propagate, and
an opening that is provided at one end of the waveguide and through which the ultrasonic waves pass.

2. The ultrasonic device according to claim 1, wherein
the ultrasonic element has a transmission and reception surface of ultrasonic waves, and
the reflection surface is provided on a perpendicular line of the transmission and reception surface.

3. The ultrasonic device according to claim 2, wherein
the perpendicular line of the transmission and reception surface is inclined with respect to a perpendicular line of the reflection surface.

4. The ultrasonic device according to claim 3, wherein
the waveguide extends along a first axis, and
the first axis is inclined in a direction different from a direction along the perpendicular line of the transmission and reception surface with respect to the perpendicular line of the reflection surface.

5. The ultrasonic device according to claim 4, wherein
the first axis is inclined with respect to a perpendicular line of an irradiated object irradiated with the ultrasonic waves.

6. The ultrasonic device according to claim 3, wherein
the housing has an ejection hole at a position different from that of the opening.

7. The ultrasonic device according to claim 6, wherein
a mesh-like protector is provided in the opening.

8. The ultrasonic device according to claim 1, wherein
the housing has a first reflection surface and a second reflection surface as the reflection surfaces,
the first reflection surface is provided on a perpendicular line of a transmission and reception surface of the ultrasonic element, and a perpendicular line of the first reflection surface is inclined with respect to the perpendicular line of the transmission and reception surface, and
a perpendicular line of the second reflection surface intersects the perpendicular line of the first reflection surface.

9. The ultrasonic device according to claim 8, wherein
an ejection hole is provided between the first reflection surface and the second reflection surface in the housing, and
the first reflection surface and the second reflection surface are provided in line symmetry with respect to a center line of the ejection hole as a center of symmetry.

10. A multi-feed detector comprising a pair of the ultrasonic devices according to claim 1 as an ultrasonic device for transmission and an ultrasonic device for reception, wherein
the ultrasonic device for transmission and the ultrasonic device for reception are disposed with a transport route of a medium in between, and
ultrasonic waves are transmitted from the ultrasonic device for transmission, the ultrasonic waves passing through the medium are received by the ultrasonic device for reception.

11. The multi-feed detector according to claim 10, wherein
multi-feed of the media is detected based on intensity of a reception signal output from the ultrasonic device for reception.

12. A transport device comprising the multi-feed detector according to claim 10.

13. A scanner comprising:
the transport device according to claim 11; and
a reader that reads an image printed on the medium.
